(19) United States
(12) Patent Application Publication
(10) Pub. No.: US 2023/0229544 A1
(43) Pub. Date: Jul. 20, 2023

(54) Presentation System Of Trouble Recovery Means, Presentation Method Of Trouble Recovery Means, And Presentation Program Of Trouble Recovery Means

(71) Applicant: SEIKO EPSON CORPORATION, Tokyo (JP)

(72) Inventor: Katsutoyo INOUE, Azumino (JP)

(21) Appl. No.: 18/154,071

(22) Filed: Jan. 13, 2023

(30) Foreign Application Priority Data
Jan. 14, 2022 (JP) 2022-004688

(51) Int. Cl. G06F 11/07

(52) U.S. Cl. CPC G06F 11/0781; G06F 11/0736

(57) ABSTRACT

A presentation system of trouble recovery means, including: an acquisition section that acquires, generated based on error time-series information, in which operation information on a robot and information on errors of the robot are linked with time, and error solution method information in which past occurrences of the errors and solution methods of the errors are linked, first information displayed as dots along time for each error number, wherein time is a first axis of a graph and error number is a second axis of the graph, second information, in which contents of errors corresponding to error numbers are displayed in language or numbers, and occurrence frequency of each error is displayed in degrees, and the third information regarding resolution means for resolving errors, the third information being generated based on the first information and the second information; and a notification section that notifies the information acquired by the acquisition section.

The present application is based on, and claims priority from JP Application Serial Number 2022-004688, filed Jan. 14, 2022, the disclosure of which is hereby incorporated by reference herein in its entirety.

### BACKGROUND

### 1. Technical Field

The present disclosure relates to a presentation system of trouble recovery means, a presentation method of trouble recovery means, and a presentation program of trouble recovery means.

### 2. Related Art

In recent years, due to soaring labor costs and a shortage of human resources, factories have been accelerating the automation of tasks that have been performed manually, using robots with robotic arms. In such robots, for example, when components malfunction, a system is used to diagnose the malfunctioning part and notify the user of the malfunction.

For example, the system described in JP-A-2005-309078 obtains operating state signals from apparatuses to be diagnosed, such as robots, indicating their operating states while they are operating under different operating conditions, and models and analyzes the causes of equipment malfunctions. Then, a failure diagnosis is performed on individual devices that constitute the apparatus to be diagnosed, and the system informs the user of the failure diagnosis as appropriate.

However, the system described in JP-A-2005-309078 requires a high level of skill for operators, service personnel, or the like who resolve problems such as failures. This makes it difficult for operators unfamiliar with troubleshooting to accurately resolve the problems.

### SUMMARY

A presentation system of trouble recovery means according to the present disclosure includes, an acquisition section that acquires, generated based on error time-series information, in which operation information of a robot and information relating to errors of the robot are linked with time, and error resolution method information, in which past occurrences of the errors and resolution methods of the errors are linked, first information displayed as dots along time for each error number, wherein time is a first axis of a graph and error number is a second axis of the graph, second information, in which contents of the errors corresponding to the error numbers are displayed in language or numbers, and a number of occurrences of each error is displayed as frequency, and third information regarding resolution means for resolving the errors, the third information being generated based on the first information and the second information and a notification section that notifies information acquired by the acquisition section.

A presentation method of trouble recovery means according to the present disclosure includes, an acquisition step of acquiring, generated based on error time-series information, in which operation information of a robot and information relating to errors of the robot are linked with time, and error resolution method information, in which past occurrences of the errors and resolution methods of the errors are linked, first information displayed as dots along time for each error number, wherein time is a first axis of a graph and error number is a second axis of the graph, second information, in which contents of the errors corresponding to the error numbers are displayed in language or numbers, and a number of occurrences of each error is displayed as frequency, and third information regarding resolution means for resolving the errors, the third information being generated based on the first information and the second information and a notifying step of notifying the information acquired in the acquisition step.

A non-transitory computer-readable recording medium having stored therein a presentation program of trouble recovery means of the present disclosure, the program being for executing an acquisition step of acquiring, generated based on error time-series information, in which operation information of a robot and information relating to errors of the robot are linked with time, and error resolution method information, in which past occurrences of the errors and resolution methods of the errors are linked, first information displayed as dots along time for each error number, wherein time is a first axis of a graph and error number is a second axis of the graph, second information, in which contents of the errors corresponding to the error numbers are displayed in language or numbers, and a number of occurrences of each error is displayed as frequency, and third information regarding resolution means for resolving the errors, the third information being generated based on the first information and the second information and a notification step of notifying the information acquired in the acquisition step.

### BRIEF DESCRIPTION OF THE DRAWINGS

FIG. 1 is a diagram showing an overall configuration of a robotic system including a presentation system of trouble recovery means according to the present disclosure.

FIG. 2 is a block diagram of the robotic system shown in FIG. 1.

FIG. 3 is a diagram showing an example of first information notified by the presentation system of trouble recovery means of the present disclosure.

FIG. 4 is a diagram showing an example of second information notified by the presentation system of trouble recovery means according to the present disclosure.

FIG. 5 is a diagram showing an example of third information notified by the presentation system of trouble recovery means according to the present disclosure.

FIG. 6 is a diagram showing an example of errors and error genre that occurred in the robot shown in FIG. 1.

FIG. 7 is a diagram showing an example of a comparison between errors that occurred in the robot shown in FIG. 1 and contents of the errors.

FIG. 8 is a diagram showing an example of errors and error histories that occurred in the robot shown in FIG. 1.

FIG. 9 is a flowchart showing an example of the presentation method of trouble recovery means.

### DESCRIPTION OF EMBODIMENT

### Embodiment

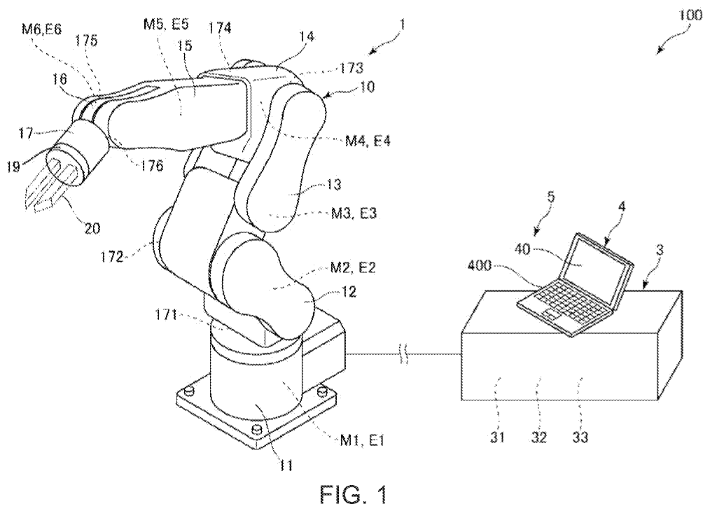

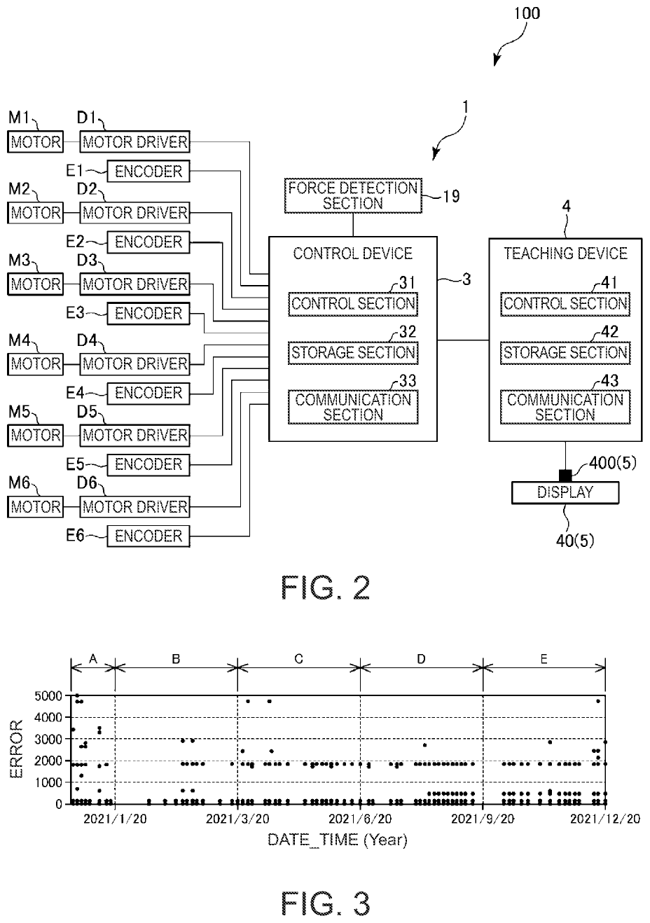

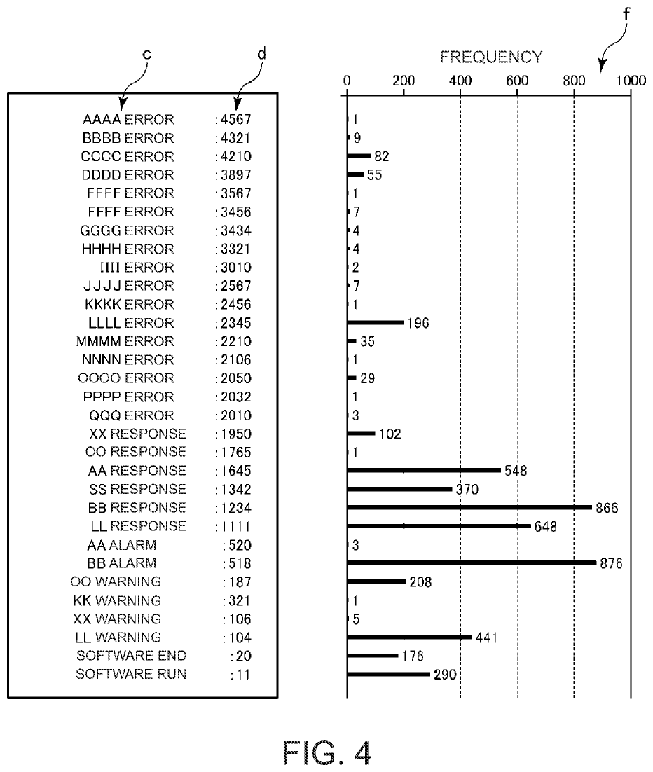

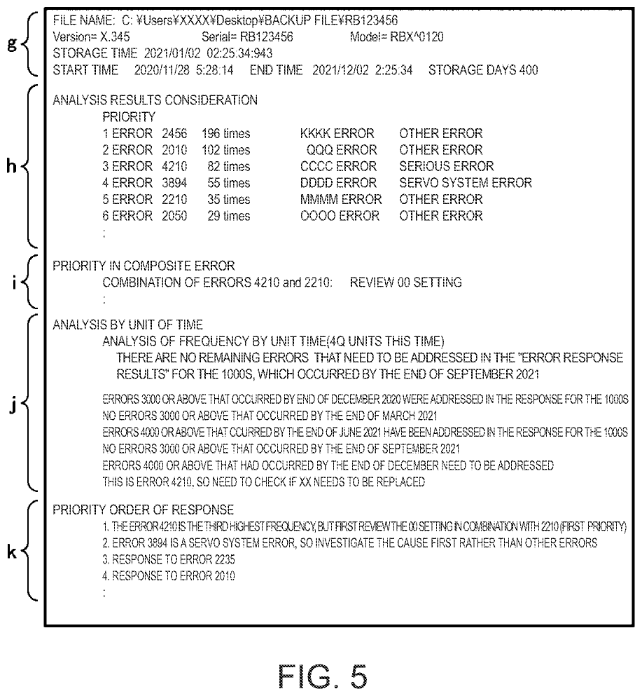

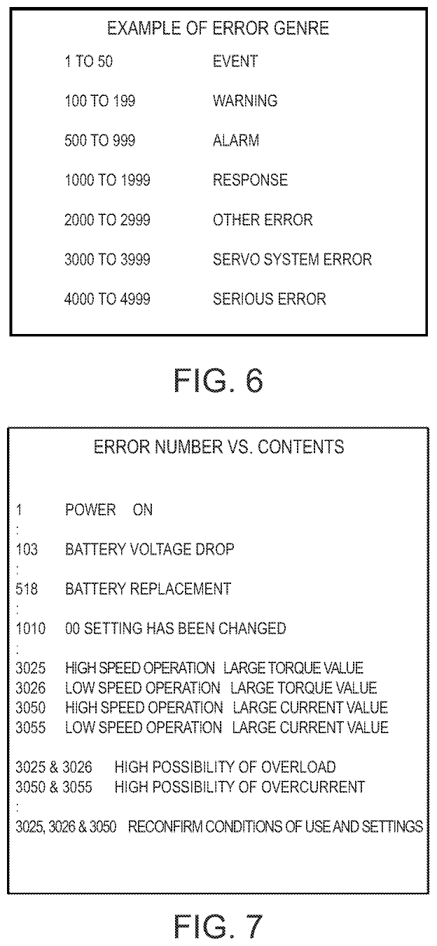

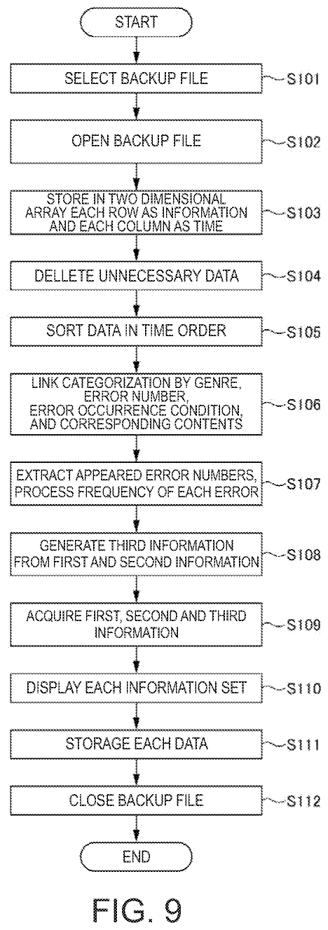

FIG. 1 is a diagram showing an overall configuration of a robotic system including a presentation system of trouble recovery means according to the present disclosure. FIG. 2 is a block diagram of the robotic system shown in FIG. 1. FIG. 3 is a diagram showing an example of first information notified by the presentation system of trouble recovery means of the present disclosure. FIG. 4 is a diagram showing an example of second information notified by the presentation system of trouble recovery means according to the present disclosure. FIG. 5 is a diagram showing an example of third information notified by the presentation system of trouble recovery means according to the present disclosure. FIGS. 6 to 8 are diagrams showing an example of errors that have occurred in the robot shown in FIG. 1 and information relating the errors. FIG. 9 is a flowchart showing an example of the presentation method of trouble recovery means.

Hereinafter, a presentation system of trouble recovery means, a presentation method of trouble recovery means, and a presentation program of trouble recovery means according to the present disclosure will be explained in detail based on preferred embodiments shown in the accompanying drawings. For convenience of explanation, the base 11 side of the robotic arm in FIG. 1 is also referred to as a “base end”, and the opposite side thereof, that is, the end effector 20 side is also referred to as a “tip end” in the following description.

As shown in FIG. 1, the robotic system 100 includes a robot 1, a control device 3 that controls the robot 1, and a teaching device 4. In this embodiment, the presentation system of trouble recovery means 5 of the present disclosure is incorporated in the teaching device 4. In other words, the presentation system of trouble recovery means 5 is composed of an acquisition section 400 and a display 40 of the teaching device 4. However, the present disclosure is not limited to this configuration, and the presentation system of the trouble recovery means 5 may be incorporated in the control device 3 or may be a remote personal computer.

First, the robot 1 will be described. The robot 1 shown in FIG. 1 is a single arm 6-axis vertical articulated robot in the present embodiment, and includes the base 11 and a robotic arm 10. Further, an end effector 20 can be attached to the tip end of the robotic arm 10. The end effector 20 may be a component of the robot 1 or may not be a component of the robot 1.

Note that the robot 1 is not limited to the shown configuration, and may be, for example, a double arm articulated robot. Further, the robot 1 may be a horizontal articulated robot.

The base 11 is a support member that supports the robotic arm 10 so as to be drivable from below, and is fixed to, for example, a floor in a factory. In the robot 1, the base 11 is electrically connected to the control device 3 via a relay cable. The connection between the robot 1 and the control device 3 is not limited to a wired connection as shown in FIG. 1, and may be, for example, a wireless connection.

In the present embodiment, the robotic arm 10 includes a first arm 12, a second arm 13, a third arm 14, a fourth arm 15, a fifth arm 16, and a sixth arm 17, and these arms are connected in this order from the base 11 side. The number of arms included in the robotic arm 10 is not limited to six, and may be, for example, one, two, three, four, five, or seven or more. In addition, the size such as total length of each arm is not particularly limited, and can be set as appropriate.

The base 11 and the first arm 12 are connected via a joint 171. The first arm 12 is rotatable with respect to the base 11 around a first rotation axis, which is parallel to the vertical direction, as a rotation center. The first rotation axis coincides with a line normal to the floor to which the base 11 is fixed.

The first arm 12 and the second arm 13 are connected via a joint 172. The second arm 13 is rotatable with respect to the first arm 12 around a second rotation axis, which is parallel to the horizontal direction, as a rotation center. The second rotation axis is parallel to an axis orthogonal to the first rotation axis.

The second arm 13 and the third arm 14 are connected via a joint 173. The third arm 14 is rotatable with respect to the second arm 13 around a third rotation axis, which is parallel to the horizontal direction, as a rotation center. The third rotation axis is parallel to the second rotation axis.

The third arm 14 and the fourth arm 15 are connected via a joint 174. The fourth arm 15 is rotatable with respect to the third arm 14 around a fourth rotation axis, which is parallel to the central axis direction of the third arm 14, as a rotation center. The fourth rotation axis is orthogonal to the third rotation axis.

The fourth arm 15 and the fifth arm 16 are connected via a joint 175. The fifth arm 16 is rotatable with respect to the fourth arm 15 around a fifth rotation axis as a rotation center. The fifth rotation axis is orthogonal to the fourth rotation axis.

The fifth arm 16 and the sixth arm 17 are connected via a joint 176. The sixth arm 17 is rotatable with respect to the fifth arm 16 around a sixth rotation axis as a rotation center. The sixth rotation axis is orthogonal to the fifth rotation axis.

Further, the sixth arm 17 is the tip end portion of robot, which is located on the most tip end portion of the robotic arm 10. The sixth arm 17 can rotate together with the end effector 20 by driving the robotic arm 10.

The robot 1 includes a motor M1, a motor M2, a motor M3, a motor M4, a motor M5, and a motor M6 as drive sections, and an encoder E1, an encoder E2, an encoder E3, an encoder E4, an encoder E5, and an encoder E6. The motor M1 is built in the joint 171, and rotates the base 11 and the first arm 12 relative to each other. The motor M2 is built in the joint 172, and rotates the first arm 12 and the second arm 13 relative to each other. The motor M3 is built in the joint 173, and rotates the second arm 13 and the third arm 14 relative to each other. The motor M4 is built in the joint 174, and rotates the third arm 14 and the fourth arm 15 relative to each other. The motor M5 is built in the joint 175, and rotates the fourth arm 15 and the fifth arm 16 relative to each other. The motor M6 is built in the joint 176 and rotates the fifth arm 16 and the sixth arm 17 relative to each other.

The encoder E1 is built in the joint 171 and detects the position of the motor M1. The encoder E2 is built in the joint 172 and detects the position of the motor M2. The encoder E3 is built in the joint 173 and detects the position of the motor M3. The encoder E4 is built in the joint 174 and detects the position of the motor M4. The encoder E5 is built in the fifth arm 16 and detects the position of the motor M5. The encoder E6 is built in the sixth arm 17 and detects the position of the motor M6. Here, “detecting the position” means detecting a rotation angle or an angular velocity of the motor.

The encoders E1 to E6 and the motors M1 to M6 are electrically connected to the control device 3, and positional information of the motors M1 to M6, that is, rotation amount, is transmitted to the control device 3 as electrical signals. Based on this information, the control device 3 drives the motors M1 to M6 via motor drivers D1 to D6 shown in FIG. 2. That is, controlling the robotic arm 10 is controlling the motors M1 to M6.

In the robot 1, a force detection section 19 that detects force is detachably attached to the robotic arm 10. The robotic arm 10 can be driven with the force detection section 19 attached. The force detection section 19 is a six-axis force sensor in the present embodiment. The force detection section 19 detects magnitude of the force on three detection axes orthogonal to each other and magnitude of the torque around the three detection axes. That is, force components in each of the axial directions of the X axis, the Y axis, and the Z axis, which are orthogonal to each other, and a force component in a W direction around the X axis, a force component in a V direction around the Y axis, and a force component in a U direction around the Z axis are detected. The X axis, the Y axis, and the Z axis are axes in a robot coordinate system. The force detection section 19 is not limited to the six-axis force sensor, and may have another configuration.

The end effector 20 can be detachably attached to the force detection section 19. In the present embodiment, the end effector 20 is configured by a hand that has a pair of claw sections that can approach and separate from each other, and that grips and releases a workpiece by the claw sections. The end effector 20 is not limited to the shown configuration, and may be a hand that holds a work object by attraction. The end effector 20 may be, for example, a polishing machine, a grinding machine, a cutting machine, or a tool such as a screw driver or a wrench.

Next, the control device 3 and the teaching device 4 will be explained. As shown in FIG. 1, in the present embodiment, the control device 3 is located at a position away from the robot 1. However, the present embodiment is not limited to this configuration, and it may be built in the base 11. The control device 3 has a function of controlling the drive of the robot 1 and is electrically connected to each section of the robot 1 described above. The control device 3 includes a control section 31, a storage section 32, and a communication section 33. These sections are communicably connected to each other via, for example, a bus.

The control section 31, for example, consists of a central processing unit (CPU), which reads and executes various programs such as an operation program stored in the storage section 32. The signals generated by the control section 31 are transmitted to and received from each section of the robot 1 via the communication section 33. This allows the robotic arm 10 to perform a predetermined work under predetermined conditions.

The storage section 32 stores various programs and the like, executable by the control section 31. The storage section 32 includes, for example, volatile memory such as random access memory (RAM), a non-volatile memory such as a read only memory (ROM), and a detachable external storage device.

The communication section 33 transmits and receives signals to and from the control device 3 using an external interface such as a wired local area network (LAN) or a wireless LAN.

As shown in FIGS. 1 and 2, the teaching device 4 has the display 40 and has a function of creating and inputting an operation program to the robotic arm 10. The teaching device 4 is not particularly limited, and examples thereof include a tablet, a personal computer, a smartphone, and a teaching pendant. An input terminal from which the video or image of the display 40 is input is the acquisition section 400.

The teaching device 4 includes a control section 41, a storage section 42, and a communication section 43. The control section 41 includes, for example, central processing unit (CPU), which reads and executes various programs such as an operation program stored in the storage section 42. The control section 41 also functions to control the operation of the display 40. The signals generated by the control section 41 are transmitted to the control device 3 via the communication section 43. This allows the user to designate a program that causes the robotic arm 10 to perform a predetermined work under a predetermined condition via the control device 3.

The storage section 42 stores various programs and the like, executable by the control section 41. The storage section 42 includes, for examples, a volatile memory such as a random access memory (RAM), a non-volatile memory such as a read only memory (ROM), and a detachable external storage device. The storage section 42 stores the presentation program of trouble recovery means of the present disclosure, error time-series information, error resolution method information, first information, second information, third information, and the like, which will be explained later.

The communication section 43 transmits and receives signals to and from the control device 3 using an external interface such as a wired local area network (LAN) or a wireless LAN.

In such a robotic system 100, errors may occur, such as failure of various sections or running out of consumable goods. By quickly resolving such troubles and immediately returning to work, the loss of productivity can be reduced. However, such trouble recovery was difficult for unexperienced operators because it required more than a certain amount of experience to analyze past history and complex errors, although methods for dealing with single error had been presented in the past. According to the present disclosure, even a novice operator can easily recover from trouble. This will be described below.

When an error occurs in the robotic system 100, error time-series information, in which information about the operation of the robot 1 and information about the error of the robot 1 are linked with time, is stored in the storage section 42. In other words, which section failed and when are stored as the error time-series information.

The types of errors include, for example, those shown in FIG. 6. In FIG. 6, the genre (type) of the error and its start number and end number are noted. For example, errors related to the “event” genre are assigned numbers 1 to 50. Further, as shown in FIG. 7, error types are assigned to numbers 1 to 5000, respectively.

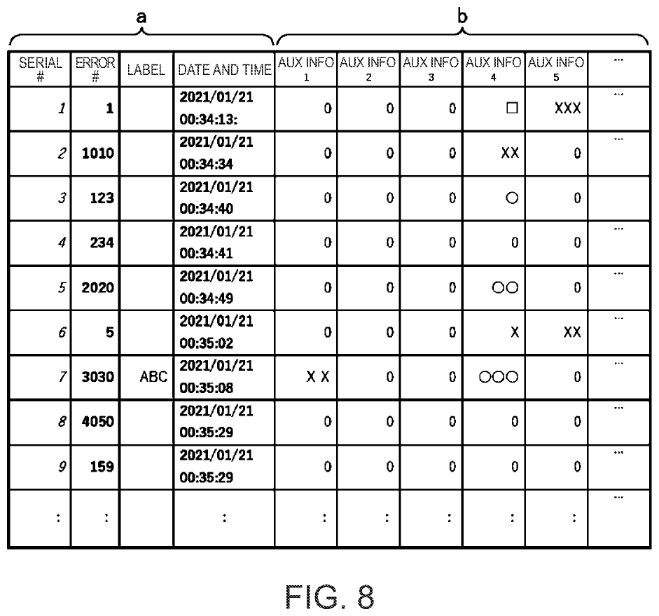

As shown in FIG. 8, when an error occurs, an item a, which includes the error number and time, and an item b, which is auxiliary information, are stored in time series. There is an upper limit to this information, for example, if the amount exceeds 5000 cases, a ring buffer function is used to overwrite and delete old data or data with low priority.

Further, as shown in FIG. 7, the error resolution method information, in which past occurrences of errors and resolution methods for the errors are linked with each other, is stored in the storage section 42. For example, an error number “1” is an error related to power-on, and an error number “103” is an error related to battery voltage drop. In this way, in FIG. 7, the words to the right side of the number indicate the meaning of that error number.

In the present embodiment, the error time-series information shown in FIG. 8 and the error resolution method information shown in FIG. 7 are stored in the storage section 42, but the present disclosure is not limited to this configuration, and may be stored in a storage section other than the storage section 42, for example, the storage section 32 or a database in a remote location. This also applies to the first information, the second information, and the third information.

When trouble occurs in the robotic system 100, the control section 41 generates the first information, the second information, and the third information based on the error time-series information and the error resolution method information, and causes the display 40 to display the generated information. The first information, the second information and the third information may be generated by a control section other than the control section 41, for example, the control section 31 or a control section in a remote location.

As shown in FIG. 3, the first information is displayed as dots along time for each error number, with the horizontal axis (first axis) of the graph as the time and the vertical axis (second axis) of the graph as error number.

On the vertical axis of the graph, numbers “1000”, “2000”, “3000”, “4000”, and “5000” are written in this order from bottom to top. Each number indicates the error numbers in the 1000s, the error numbers in the 2000s, the error numbers in the 3000s, the error number in the 4000s, and the error numbers in the 5000s.

On the horizontal axis of the graph, “2021/1/20,” “2021/3/20,” “2021/6/20,” “2021/9/20,” and “2021/12/20” are written in order from left to right. Each one indicates date and time.

In this graph, the error number and time are indicated as dots, that is, plotted, whenever an error occurs. According to such first information, even a novice operator can know at a glance what errors occurred and how often the errors occurred.

In this manner, the first information (as well as for the second information to be described later) is displayed in time series for each unit of time. This allows the operator to easily know errors that have occurred in a predetermined period in time series.

Further, the first information may be configured such that, when a dot of the graph is chosen, the details thereof are displayed.

Further, the first information may be configured to change the time axis to daily, weekly, monthly, or the like for each error or each genre of error. Further, the first information may present further suggestions after a statistical analysis.

As shown in FIG. 4, the second information indicates the error contents corresponding to the error number by words or number, and indicates the number of occurrence of each error as frequency. An item d, the error number, is written in numbers on the right side of the item c of the error contents.

In FIG. 4, the item c, the error contents, is represented by the words “AAAA ERROR” to “QQQ ERROR” and “XX RESPONSE” to “SOFTWARE RUN”. The item d, error number, is described by a four digit numbers. The numbers on the right side of the error contents are the error numbers.

A bar graph f, to the right side of the item d, is a graph in which the vertical axis represents an error type and the horizontal axis represents a frequency. In this graph, whenever an error occurs, the error is counted and the bar extends to the right. The frequency of occurrence is also indicated numerically on the right side of the bar.

This second information allows even a novice operator to know at a glance what errors occurred and how often the errors occurred. Further, since the graph form of the second information and the first information are different, it is easier to know what errors have occurred and how often, by the synergistic effect of the first information and the second information.

The second information may be operable in order of error numbers or in order of occurrence frequency.

Further, the second information may be displayed in detail by choosing an optional position in the bar graph f.

In this manner, the first information and the second information are categorized into error types and displayed according to type of error. This allows the operator to know at a glance what errors occurred and when errors frequently occurred.

As shown in FIG. 5, the third information is generated based on the first information and the second information and relates to resolution means for resolving errors.

As shown in FIG. 5, the third information includes an item g, which includes file name, version, serial number, model, storage time, start time, end time, and the number of storage days, and like, an item h, which is analysis results consideration, an item i, which is a priority in composite errors, an item j, which is analysis by unit of time, and an item k, which is priority order of response.

In the item h of “analysis results consideration”, error number, number of occurrences, and error type are prioritized as one group and displayed in order from the top of the priority. That is, the error on the upper side is a serious error and one that the operator should address immediately.

The item i, “priority in composite error”, is the item indicating which setting is to be reviewed when two or more errors have occurred. For example, it says “the combination of error 4210 and error 2210 is review 00 setting”, so the operator can immediately know where to review even in the event of a composite error.

Further, as shown in FIG. 3, the frequency of errors can also be analyzed by unit of time, for example, by dividing the year into quarters and totaling the frequency by quarter. Specifically, by totaling the errors for each of periods A, B, C, D, and E, we can see that in period A, the number of errors in the 4000s comparatively common, but as time passes from period C to period E, the errors in the 4000s tends to decrease. On the other hand, we can see that the errors in the 1000s tend to increase in order in periods A, B, C, D and E.

In this way, by displaying the change in frequencies per unit of time, the operator can be made aware of error trends. As a result, the operator can respond quickly and accurately, taking the trends into account.

An item j, “analysis by unit of time” shown in FIG. 5, is the item that indicates error responses that remain within a predetermined period based on a frequency analysis in units of time. For example, because the following are indicated, the operator knows immediately what to do: “there are no remaining errors that need to be addressed in the “error response results” for the 1000s that occurred by the end of September 2021,” “errors 3000 and above that had occurred by the end of December 2020, have been addressed in the response for the 1000s,” “no errors 3000 and above that occurred by the end of March 2021,” “errors 4000 and above that occurred by the end of June 2021, have been addressed in the response for the 1000s,” “no errors 3000 and above that occurred by the end of September 2021,” and “errors 4000 and above that had occurred by the end of December 2021, need to be addressed. This is error 4210, so need to check if XX needs to be replaced”.

The item k, “priority order of response”, is the item indicating the priority of an error to be addressed. For example, by describing “Error 4210 is the third highest frequency, but first review the 00 setting in combination with 2210 (first priority)”, “Error 3894 is a servo system error, so investigate the cause first before any other errors”, “Response to error 2235”, and “Response to error 2010”, the operator can immediately know which response should be taken first.

This third information, which automatically analyzes the cause-and-effect relationships, allows operators to quickly determine which error should be addressed and how, and, if more than one error has occurred, which error should be addressed first.

In such a presentation system of trouble recovery means 5, the first information, the second information, and the third information are notified and displayed in the present embodiment, so that even a novice operator can easily recover from the trouble. Therefore, productivity loss can be effectively suppressed.

Desirably, the third information is linkable to a database relating to at least one of operation manuals, parts replacement procedures, and past quality problems. In other words, it is desirable to be configured to link to a page of the information on the selected content when any one of the operation manuals, the parts replacement procedures, and the past quality problems is selected. This allows the operator to see the third information and learn more detailed information as needed.

It is also desirable that the third information includes a plurality of different resolution means. This allows the operator to choose a resolution method that the operator has experience with or could understand easily, as appropriate.

It is also desirable that the plurality of different resolution means are prioritized according to their resolution potential. This allows the operator to make an appropriate choice, depending on the situation, as to which resolution means to choose.

It is also desirable that the third information is categorized into error types and that the error types are displayed distinctively. This enables the operator to know at a glance the types of error that have occurred.

As described above, the presentation system of trouble recovery means 5 includes, the acquisition section 400 that acquires, generated based on error time-series information, in which operation information of the robot 1 and information relating to errors of the robot 1 are linked with time, and the error resolution method information, in which past occurrences of errors and methods for resolving the errors are linked, first information displayed as dots along time for each error number, wherein time is a first axis of a graph and error number is a second axis of the graph, second information, in which contents of errors corresponding to error numbers are displayed in language or numbers, and occurrence frequency of each error is displayed in degrees, and the third information regarding resolution means for resolving the errors based on the first information and the second information; and the display 40, which is an example of the notification section that notifies the information acquired by the acquisition section 400. This allows the operator to know at a glance from the first information and the second information what kind of error has occurred and how often, and from the third information to know accurately the resolution means for the errors. Therefore, even a novice operator can easily recover from the trouble.

In the above description, the first information, the second information, and the third information are information related to errors that occurred in the robot 1, but the present disclosure is not limited thereto, and may be information related to errors that occurred in a robot other than the robot 1. This is effective when the robot 1 or the control device 3 is in an offline state.

Further, the first information, the second information, and the third information may be collectively displayed on the display 40 at the same timing, or may be switchably displayed at different times.

Each of the first information, the second information, and the third information may be displayed in a scrolling manner.

In addition, the first information, the second information, and the third information may each be windowed, and the position of each window may be configured to allow the operator to change the position of each window as desired.

Further, each of the first information, the second information, and the third information may each be configured to be displayed in detail when its text portion is selected.

The displayed first, second, and third information may be configured to be stored in the storage section 42 or the like, as image data, respectively.

In addition, in this embodiment, a case of presenting a recovery method from trouble that occurred in the robot 1 is described, but the present disclosure is not limited thereto, and, for example, a recovery method from trouble that occurred in a robot such as a printing apparatus may be presented.

Next, an example of a presentation method of trouble recovery means will be described with reference to a flowchart shown in FIG. 9. The following description is a control operation performed by the control section 41 after an error has occurred.

First, in step S101, a backup file is selected. In other words, a region is selected to store the error time-series information, which is operation information of the robot 1 when an error occurred and information related to the error of the robot 1 are linked with time.

Next, in step S102, a backup file is opened. Next, in step S103, error information is stored in a two dimensional array with each row as information and each column as time.

Next, in step S104, for example, if the number of information is less than 5000, unnecessary data in regions with no information is deleted.

Then, in step S105, the data is sorted in time order. In other words, the error data is rearranged in chronological order. This is because when the number of data exceeds 5000, the ring buffer wraps around and the times will no longer be in ascending order.

Next, in step S106, categorization of each genre, error number, occurrence condition thereof, and corresponding contents are linked with each other. Through such steps S101 to S106, the above described first information is generated.

Next, in step S107, the error numbers that appeared are extracted and the occurrence frequency of each error is processed. As a result, the above described second information is generated.

Next, in step S108, the above described third information is generated from the first information and the second information. That is, from the first information and the second information, the data is sorted in order of most frequent errors, the resolution means obtained by combining error numbers from the historical data is obtained, and the like.

Next, in step S109, the first information, the second information, and the third information are acquired. Note that this step is performed by the acquisition section 400 acquiring image data of the first information, the second information, and the third information from the control section 41. This step S109 is an acquisition step.

Then, in step S110, each image is displayed on the display 40. This step S110 is a notification step. This allows the operator to know at a glance from the first information and the second information what kind of error has occurred and how often, and from the third information to know accurately the resolution means for the errors. Therefore, even a novice operator can easily recover from the trouble.

Next, in step S111, each data set is stored. That is, the first information, the second information, and the third information are stored in the storage section 42 as image data or text data. Then, in step S112, the backup file is closed and the process ends.

As described above, the presentation method of trouble recovery means includes, an acquisition step of acquiring, generated based on error time-series information, in which operation information of the robot 1 and information relating to errors of the robot 1 are linked with time, and the error resolution method information, in which past occurrences of errors and methods for resolving the errors are linked, first information displayed as dots along time for each error number, wherein time is a first axis of a graph and error number is a second axis of the graph, second information, in which contents of errors corresponding to error numbers are displayed in language or numbers, and occurrence frequency of each error is displayed in degrees, and the third information regarding resolution means for resolving errors, the third information being generated based on the first information and the second information; and a notifying step of notifying the information acquired in the acquisition step. This allows the operator to know at a glance from the first information and the second information what kind of error has occurred and how often, and from the third information to know accurately the resolution means for the errors. Therefore, even a novice operator can easily recover from the trouble.

As described above, a non-transitory computer readable recording medium having stored therein a presentation program of trouble recovery means, having an acquisition step of acquiring, generated based on error time-series information, in which operation information of the robot 1 and information relating to errors of the robot 1 are linked with time, and the error resolution method information, in which past occurrences of errors and methods for resolving the errors are linked, first information displayed as dots along time for each error number, wherein time is a first axis of a graph and error number is a second axis of the graph, second information, in which contents of errors corresponding to error numbers are displayed in language or numbers, and occurrence frequency of each error is displayed in degrees, and third information regarding to the resolution means for resolving errors based on the first information and the second information, and a notifying step of notifying the information acquired in the acquisition step. By executing such a program, it allows the operator to know at a glance from the first information and the second information what kind of error has occurred and how often, and from the third information to know accurately the resolution means for the errors. Therefore, even a novice operator can easily recover from the trouble.

Note that the presentation program of trouble recovery means of the present disclosure may be stored in the storage section 42, in a recording medium such as a CD-ROM, for example, or in a storage device that can be connected via a network or the like.

Although the presentation system of trouble recovery means, the presentation method of trouble recovery means, and the presentation program of trouble recovery means according to the present disclosure have been explained above with reference to the embodiments shown in the drawings, the present disclosure is not limited thereto. In addition, each step and each section of the robot control method and the robotic system can be replaced with an arbitrary step and an arbitrary structure capable of exhibiting the same function. Further, an arbitrary step or structure may be added.

What is claimed is:

1. A presentation system of trouble recovery means, comprising:
an acquisition section that acquires, generated based on error time-series information, in which operation information of a robot and information relating to errors of the robot are linked with time, and error resolution method information, in which past occurrences of the errors and resolution methods of the errors are linked,
first information displayed as dots along time for each error number, wherein time is a first axis of a graph and error number is a second axis of the graph,
second information, in which contents of the errors corresponding to the error numbers are displayed in language or numbers, and a number of occurrences of each error is displayed as frequency, and
third information regarding resolution means for resolving the errors, the third information being generated based on the first information and the second information and
a notification section that notifies information acquired by the acquisition section.

2. The presentation system of trouble recovery means according to claim 1, wherein:
the first information and the second information are displayed in time-series by unit of time.

3. The presentation system of trouble recovery means according to claim 1, wherein:
the first information and the second information are categorized into and displayed according to error type.

4. The presentation system of trouble recovery means according to claim 1, wherein:
the third information can be linked to a database relating to at least one of operation manuals, parts replacement procedures, and past quality problems.

5. The presentation system of trouble recovery means according to claim 1, wherein:
the third information includes a plurality of different resolution means.

6. The presentation system of trouble recovery means according to claim 5, wherein:
the plurality of different resolution means are prioritized according to their resolution potential.

7. The presentation system of trouble recovery means according to claim 1, wherein:
the third information is categorized into error types and the error types are displayed distinctively.

8. A presentation method of trouble recovery means, comprising:
an acquisition step of acquiring, generated based on error time-series information, in which operation information of a robot and information relating to errors of the robot are linked with time, and error resolution method information, in which past occurrences of the errors and resolution methods of the errors are linked,
first information displayed as dots along time for each error number, wherein time is a first axis of a graph and error number is a second axis of the graph,
second information, in which contents of the errors corresponding to the error numbers are displayed in language or numbers, and a number of occurrences of each error is displayed as frequency, and
third information regarding resolution means for resolving the errors, which is generated based on the first information and the second information; and
a notifying step of notifying the information acquired in the acquisition step.

9. A non-transitory computer-readable recording medium having stored therein a presentation program of trouble recovery means, having:
an acquisition step of acquiring, generated based on error time-series information, in which operation information of a robot and information relating to errors of the robot are linked with time, and error resolution method information, in which past occurrences of the errors and resolution methods of the errors are linked,
first information displayed as dots along time for each error number, wherein time is a first axis of a graph and error number is a second axis of the graph,
second information, in which contents of the errors corresponding to the error numbers are displayed in language or numbers, and a number of occurrences of each error is displayed as frequency, and
third information regarding resolution means for resolving the errors, which is generated based on the first information and the second information; and
a notification step of notifying the information acquired in the acquisition step.
